(19) United States
(12) Patent Application Publication
(10) Pub. No.: US 2009/0151651 A1
(43) Pub. Date: Jun. 18, 2009

(54) Stretchable Leash and Assembly

(76) Inventors: Patrick Robert Charrin, North Hollywood, CA (US); Daniel Thomas Troutman, Los Angeles, CA (US)

Correspondence Address: LAW OFFICES OF BRUCE D. LATHROP, 444 S. FLOWER ST., STE. 1750, LOS ANGELES, CA, 90071, US

(21) Appl. No.: 12/331,703

(22) Filed: Dec. 10, 2008

Related U.S. Application Data
(60) Provisional application No. 61/007,489, filed on Dec. 13, 2007.

(51) Int. Cl. A01K 27/00

(52) U.S. Cl. 119/798

(57) ABSTRACT

A stretchable leash and assembly is disclosed for a handler's restraint or control of an animal or human subject made from an elastic material or fabric. The leash material or fabric has a cross section with its width substantially longer than its height. At its distal end, a small length of the leash material or fabric is overlapped and thereby looped upon itself by running the distal end through a buckle or hoop attached to a clasp and securely attaching the distal end to a portion of the overlapped length of the leash material or fabric. At its proximal end, a longer length of the leash material or fabric is overlapped and thereby looped upon itself and securely attached to a portion of the overlapped length to form a loop handle.

This application claims priority to U.S. provisional patent application Ser. No. 61/007,489, entitled STRETCHABLE LEASH AND ASSEMBLY, filed on Dec. 13, 2007.

We, Patrick Charrin and Daniel Troutman, have invented a stretchable leash for a handler's restraint or control of an animal or human subject made from an elastic material or fabric with a lengthwise elastic limit at least five percent greater than its unstrained length. This leash material or fabric has a cross section with its width substantially longer than its height. At its distal end, a small length of the leash material or fabric is overlapped and thereby looped upon itself by running the distal end through a buckle or hoop attached to a clasp and securely attaching the distal end to a portion of the overlapped length of the leash material or fabric. At its proximal end, a longer length of the leash material or fabric is overlapped and thereby looped upon itself and securely attached to a portion of the overlapped length to form a loop handle.

The leash material or fabric can be selected from materials or fabric know in the art based on the desired length of the leash and load rating specifications for such material and observed or published minimum pull strengths for various subjects. For example, different leash material or fabric can be specified based on the pull strengths of a 75-pound dog or that of a 20-pound dog. Alternatively, one could specify leash material or fabric based on the minimum pull strength required for a 75-pound dog, knowing that said leash material or fabric would also be adequate to restrain and control a 20-pound dog. The minimum pull strength can be appropriately increased by a predetermined multiple to account for variations in pull strength due to differences among breeds or species and the age and health of the subjects.

### ADVANTAGES

One advantage of the invention over the prior art is that the leash offers desired restraint and control of the subject, while at the same time, dampening shock transmission to the handler and the subject from the abrupt, non-directed movements of the subject. For example, the dampening effect of the leash will reduce the strain and discomfort of the handler in the hand to shoulder region. If the subject is an animal with a collar, the dampening effect of the leash will reduce the strain and discomfort in the neck and throat area of the subject.

Another advantage of the invention over the prior art is to reduce the complexity of the leash by reducing the number of separate parts. This will make the leash easier to use, more reliable, longer lasting, and reduce the cost of the leash to the consumer by reducing the cost to manufacturer it.

Another advantage of the invention over the prior art is that the elasticity in the loop handle allows for use of larger hitching posts or other anchoring objects because the handle can be stretched to fit over said posts or objects.

An advantage of one embodiment of the invention over the prior art is that it's woven fabric material makes it look and feel like a traditional animal leash and fabric animal collar, unlike many stretch leashes made from bungee-cord material.

Another advantage of a woven fabric embodiment over the prior art is that the use of woven fabric elastic allows the leash to be fixed securely through stitching.

### DETAILED DESCRIPTION

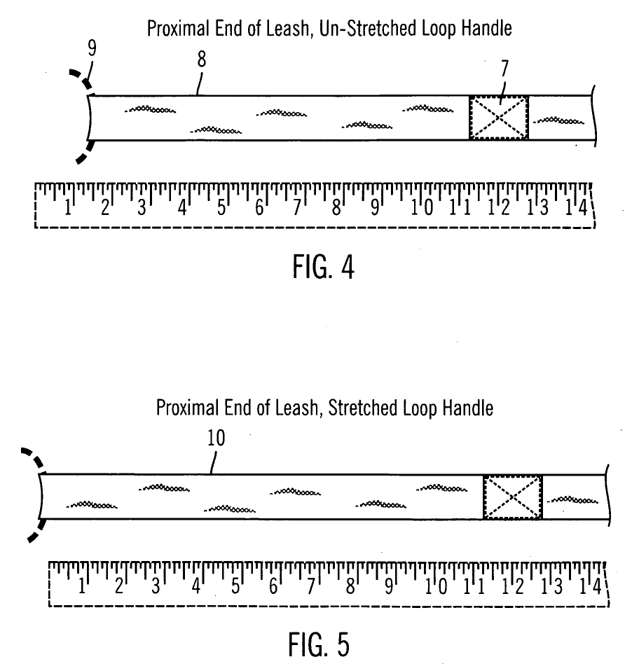

In one embodiment, a stretchable leash comprises an elastic material or fabric 1 with a lengthwise elastic limit at least five percent greater than its unstrained length. This leash material or fabric has a rectangular cross section with its width substantially longer than its height as shown in FIG. 2, where the leash is twisted to show its relative width and height 2. At its distal end, shown at FIG. 3, a small length of the leash is overlapped 3 and thereby looped upon itself at one end by running the distal end through a buckle or hoop 4 attached to a clasp 5 and securely attaching the distal end to a portion of the overlapped length of the leash 6. At its proximal end, shown in FIG. 4, a longer length of the leash material or fabric is overlapped and thereby looped upon itself and securely attached to a portion of the overlapped length 7 to form a loop handle 8. This loop handle can be placed over an anchoring object 9 to secure the leash when not held by the handler.

In one embodiment, the leash material or fabric 1 can be selected from material or fabric know in the art based on the desired length of the leash and load rating specifications for such material and observed or published minimum pull strengths for various subjects. For example, different leash material or fabric can be specified based on the pull strengths of a 75-pound dog or that of a 20-pound dog. Alternatively, one can specify leash material or fabric based on the minimum pull strength required for a 75-pound dog, knowing that said leash material or fabric would also be adequate to restrain or control a 20-pound dog. The minimum pull strength can be appropriately increased by a predetermined multiple to account for variations in pull strength due to differences among breeds or species and the age and health of the subjects.

In one embodiment, the entire length of the leash material or fabric 1 comprises the same elastic material or fabric with a lengthwise elastic limit at least 10 percent greater than its unstrained length and, therefore, it can be stretched along its total length. For example, FIG. 4 and FIG. 5 show the loop handle section of one embodiment in the un-stretched and stretched states, respectively. The stretched loop handle 10 is approximately 1.5 inches longer than the un-stretched loop handle 8.

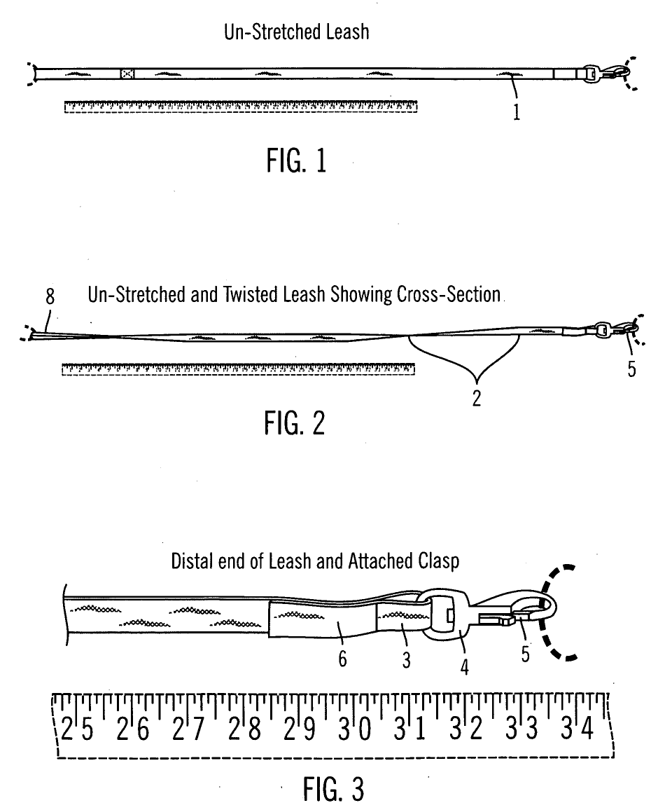

In one embodiment depicted in FIGS. 1-5, the leash material or fabric 1 is a relatively flat and narrow woven fabric strip with a lengthwise elastic limit that is at least 15 percent greater than its unstrained length. The buckle or hoop 4 is rotatively attached to a collar clasp 5 to create a swivel hook clasp that can be attached to the animal's collar. The distal loop 3 is threaded through the buckle or hoop 4 and sown securely to a portion of the overlapped length of the leash 6. The loop handle 8 on the proximal end is also sown securely to a portion of the overlapped length of the leash 7.

In one embodiment, the leash material or fabric is a woven, flat, elastic strap distributed by National Webbing Products, as Model AE-1.

For alternative embodiments, the leash material or fabric can have a lengthwise elastic limit that is up to 80 percent greater than its unstrained length and still be within the scope of the invention.

It will be apparent to those skilled in the art that changes and modifications may be made in the embodiments illustrated and described, without departing from the spirit and the scope of the invention. Thus, the invention is not to be limited to the particular forms herein shown and described except insofar as indicated by the scope of the appended claim.

Having thus described our invention, we claim:

1. A leash comprising a stretchable material fixed at one end to a clasp and at the other end looped back onto itself to form a handle by securing said other end to said stretchable material.
